(19) United States
(12) Patent Application Publication
(10) Pub. No.: US 2022/0301003 A1
(43) Pub. Date: Sep. 22, 2022

(54) AREA SPECIFYING SYSTEM

(71) Applicant: NTT DOCOMO, INC., Chiyoda-ku (JP)

(72) Inventors: Tomohiro NAKAGAWA, Chiyoda-ku (JP); Takuya DOUMEN, Chiyoda-ku (JP); Kazuya SASAKI, Chiyoda-ku (JP)

(73) Assignee: NTT DOCOMO, INC., Chiyoda-ku (JP)

(21) Appl. No.: 17/608,829

(22) PCT Filed: Apr. 28, 2020
(86) PCT No.: PCT/JP2020/018152

§ 371 Date: Nov. 4, 2021

(30) Foreign Application Priority Data
May 8, 2019 (JP) 2019-088125

(51) Int. Cl. G06Q 30/02; H04R 29/00; H04R 1/02; H04R 3/00

(52) U.S. Cl. CPC G06Q 30/0246; H04R 29/001; H04R 1/028; H04R 3/00; H04R 2499/15

(57) ABSTRACT

An area specifying system is a system for specifying an area in which information presented by an information medium is recognizable as the information, and includes a medium position information acquisition unit configured to acquire medium position information indicating a position in which the information medium is provided, an area specifying information acquisition unit configured to acquire area specifying information related to at least one of attributes of the information medium and content of the information presented by the information medium, and a specifying unit configured to specify the area based on the medium position information acquired by the medium position information acquisition unit and the area specifying information acquired by the area specifying information acquisition unit.

### TECHNICAL FIELD

The present invention relates to an area specifying system that specifies an area in which information presented by an information medium can be recognized as the information.

### BACKGROUND ART

In the related art, a technology for generating a so-called visibility map, which calculates an area in which a structure, a mountain, or the like can be seen, in consideration of a position, shape, and the like of obstacles, is known (see, for example, Patent Literature 1).

### CITATION LIST

### Patent Literature

[Patent Literature 1] Japanese Unexamined Patent Publication No. 2016-48238

### SUMMARY OF INVENTION

### Technical Problem

When an advertising space for an advertisement presented outdoors is sold, it is important how many people will see the advertisement. As one of indicators therefor, for example, it is conceivable to use how many people pass through an area in which the advertisement can be seen. In order to estimate a traffic volume of people in an area, it is necessary to specify an area in which an advertisement can be seen. It is conceivable to use a technology for generating a visibility map to specify the area. However, the visibility map only shows an area in which structures, mountains, and the like can be physically seen. Therefore, even when a person at a position in the area shown on the visibility map can see the advertisement, the person is not able to appropriately recognize the advertisement as an advertisement in some cases. Further, a similar problem can occur when an advertisement is performed using sound.

One embodiment of the present invention has been made in view of the above, and an object of the present invention is to provide an area specifying system capable of specifying an area in which information such as an advertisement can be appropriately recognized.

### Solution to Problem

In order to achieve the above object, an area specifying system according to an embodiment of the present invention is an area specifying system for specifying an area in which information presented by an information medium is recognizable as the information, the area specifying system including: a medium position information acquisition unit configured to acquire medium position information indicating a position at which the information medium is provided; an area specifying information acquisition unit configured to acquire area specifying information related to at least one of attributes of the information medium and content of the information presented by the information medium; and a specifying unit configured to specify the area based on the medium position information acquired by the medium position information acquisition unit and the area specifying information acquired by the area specifying information acquisition unit.

In the area specifying system according to the embodiment of the present invention, specifying of the area is performed based on the area specifying information related to at least one of the attributes of the information medium and the content of the information presented by the information medium. Therefore, it is possible to specify an area in which information such as an advertisement can be appropriately recognized.

### Advantageous Effects of Invention

According to an embodiment of the present invention, it is possible to specify an area in which information such as advertisements can be appropriately recognized.

### BRIEF DESCRIPTION OF DRAWINGS

FIG. 1 is a diagram illustrating a configuration of an area specifying system according to an embodiment of the present invention.

FIG. 2 is a diagram illustrating an example of an area that is specified by the area specifying system.

FIG. 3 is a diagram illustrating an example of an area that is specified by the area specifying system.

FIG. 4 is a diagram illustrating an example of a candidate area that is a candidate for a visible area.

FIG. 5 is a diagram illustrating specifying the visible area using obstacle information.

FIG. 6 is a diagram illustrating an example of a candidate area that is a candidate for an acoustic reach area.

FIG. 7 is a diagram illustrating specifying of the acoustic reach area using obstacle information.

FIG. 8 is a flowchart illustrating a process that is executed by the area specifying system according to the embodiment of the present invention. FIG. 9 is a diagram illustrating a hardware configuration of the area specifying system according to the embodiment of the present invention.

### DESCRIPTION OF EMBODIMENTS

Hereinafter, embodiments of an area specifying system according to the present invention will be described in detail together with the drawings. In the description of the drawings, the same elements are denoted by the same reference numerals, and duplicate description thereof will be omitted.

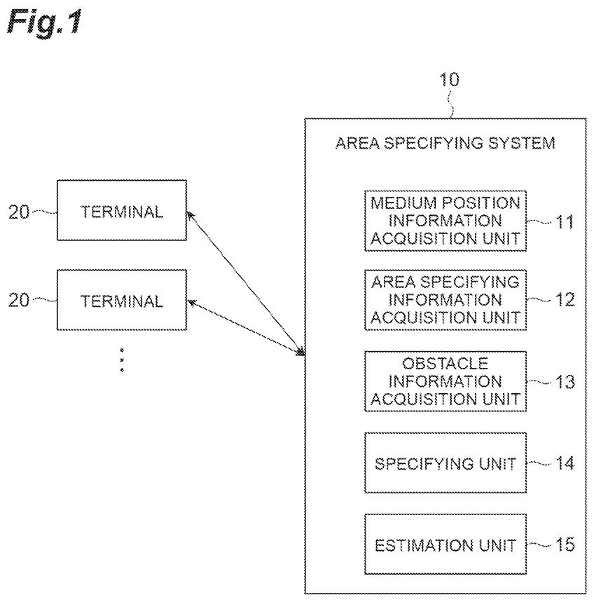

FIG. 1 illustrates an area specifying system 10 according to the embodiment. The area specifying system 10 is a system (device) that specifies an area in which information presented by an information medium can be recognized as the information. In the embodiment, the information presented by the information medium is an advertisement. The advertisement is output as an image (video) and audio from a device which is an information medium (advertising medium) including, for example, a display and a speaker. The device may include either a display or a speaker. That is, the advertisement may be output as either an image or an audio. The device is located and fixedly installed outdoors such as on a building in a city. That is, the area specifying system 10 specifies an area in which an advertisement presented outdoors can be visually or audibly recognized as an advertisement by a person located in the area. Being recognizable as an advertisement means that the content of the advertisement can be appropriately ascertained, rather than simply being physically visible or audible. The area is, for example, a passageway that a passerby can pass through.

The area in which the advertisement can be recognized changes depending on attributes (characteristics) of the device that presents the advertisement, and the advertisement (content) itself. The area specifying system 10 appropriately specifies an area in consideration of these.

The area specified by the area specifying system 10 is used for evaluation of the advertisement or an advertising space provided with a device that performs advertisement. A value of the advertisement or the advertising space is determined depending on how many people can see the advertisement, for example, a traffic volume in the area. In addition to specifying the area, the area specifying system 10 may estimate the traffic volume as the number of people who can recognize the advertisement, as will be described below.

The area specifying system 10 is realized by, for example, a server device. Further, the area specifying system 10 may be realized by a plurality of server devices, that is, a computer system. The area specifying system 10 receives information transmitted from a terminal 20 and estimates the traffic volume based on the received information.

The terminal 20 has a positioning function for the terminal 20 such as a global positioning system (GPS) positioning function, and acquires position information indicating a position of the terminal 20. The acquired position information is, for example, information indicating a latitude and longitude of the position of the own terminal 20. However, the position information may be information other than the latitude and longitude. In addition to GPS positioning, positioning using the terminal 20 may be performed using a method of the related art using radio waves of a wireless LAN (for example, Wi-Fi (registered trademark)), a beacon, or the like, or a method of the related art using radio waves of a mobile phone base station. The terminal 20 transmits the acquired position information to the area specifying system 10.

Subsequently, a function of the area specifying system 10 according to the embodiment will be described. As illustrated in FIG. 1, the area specifying system 10 includes a medium position information acquisition unit 11, an area specifying information acquisition unit 12, an obstacle information acquisition unit 13, a specifying unit 14, and an estimation unit 15.

The medium position information acquisition unit 11 is a functional unit that acquires medium position information indicating a position in which an information medium is provided. The medium position information acquisition unit 11 acquires, for example, information indicating a latitude, longitude, and altitude of a position at which the device 40, which is an information medium, is provided as the medium position information. Further, the medium position information acquisition unit 11 may acquire information indicating a direction in which the information medium is provided (a direction in which the advertisement is output) as the medium position information. For example, the medium position information acquisition unit 11 acquires the medium position information by receiving an input operation from an administrator of the area specifying system 10. The medium position information acquisition unit 11 outputs the acquired medium position information to the specifying unit 14.

The area specifying information acquisition unit 12 is a functional unit that acquires area specifying information related to at least one of the attributes of the information medium and content of the information presented by the information medium. The area specifying information is information on elements that can affect an area to be specified. The area specifying information may include information related to an information medium that presents an advertisement, and information related to an advertisement (presented information). The area specifying information acquisition unit 12 may acquire information indicating a capability of the information medium as the area specifying information. Specifically, the area specifying information acquisition unit 12 acquires the following area specifying information.

When the information medium includes a display and the advertisement includes an image, the area specifying information acquisition unit 12 acquires area specifying information related to these. For example, the area specifying information acquisition unit 12 may acquire information indicating a size of the display as information related to the display. In addition, the area specifying information acquisition unit 12 may acquire information indicating a viewing angle and luminance of the display as information indicating the capability of the display. The area specifying information acquisition unit 12 may acquire either information indicating the viewing angle of the display or information indicating the luminance of the display. Information indicating physical attributes of the device (housing) 40, which is an information medium, may be used as the area specifying information.

The area specifying information acquisition unit 12 may acquire information indicating a size of an object displayed by the display. For example, the area specifying information acquisition unit 12 acquires information indicating a size of letters, characters, logos, or the like in the advertisement (content).

When the information medium includes a speaker and the advertisement includes audio, the area specifying information acquisition unit 12 acquires area specifying information related to these. For example, the area specifying information acquisition unit 12 may acquire information indicating a directionality of sound output of the speaker and a volume with which sound can be output as information indicating a capability (acoustic output performance) of the speaker. The area specifying information acquisition unit 12 may acquire either information indicating the directionality of the sound output of the speaker or information indicating a volume with which sound can be output by the speaker. The directionality of the speaker is, for example, a direction and angle at which sound is output. The volume with which sound can be output by the speaker is a maximum volume (allowable input volume) with which the speaker can output sound.

The area specifying information acquisition unit 12 may acquire information related to sound output from the speaker. For example, the area specifying information acquisition unit 12 acquires information indicating a volume of an advertisement (content) that is output as sound (a volume at which content is output; a playback volume). The area specifying information acquisition unit 12 may acquire only a part of the above-described area specifying information.

For example, the area specifying information acquisition unit 12 acquires the area specifying information by receiving an input operation from the administrator of the area specifying system 10. For information related to the advertisement (content) (for example, a size of an object that is displayed), information for each advertisement may be determined in advance by the administrator of the area specifying system 10, for example, and the information may be generated. Alternatively, the area specifying information acquisition unit 12 may analyze the advertisement to generate and acquire the area specifying information. The area specifying information acquisition unit 12 outputs the acquired area specifying information to the specifying unit 14.

The obstacle information acquisition unit 13 is a functional unit that acquires obstacle information indicating obstacles around the position at which the information medium is provided. An obstacle is an object that becomes an obstacle for recognizing an advertisement, and is, for example, a structure such as buildings around the position at which the information medium is provided. The obstacle information acquisition unit 13 acquires, for example, information indicating a latitude, longitude and altitude of a position of the structure, and information indicating a shape of the structure and a height of the structure as obstacle information. For example, the obstacle information acquisition unit 13 acquires obstacle information, for example, by receiving an input operation from the administrator of the area specifying system 10. The obstacle information acquisition unit 13 outputs the acquired obstacle information to the specifying unit 14.

The specifying unit 14 is a functional unit that specifies an area based on the medium position information acquired by the medium position information acquisition unit 11 and the area specifying information acquired by the area specifying information acquisition unit 12. The specifying unit 14 specifies the area also based on the obstacle information acquired by the obstacle information acquisition unit 13.

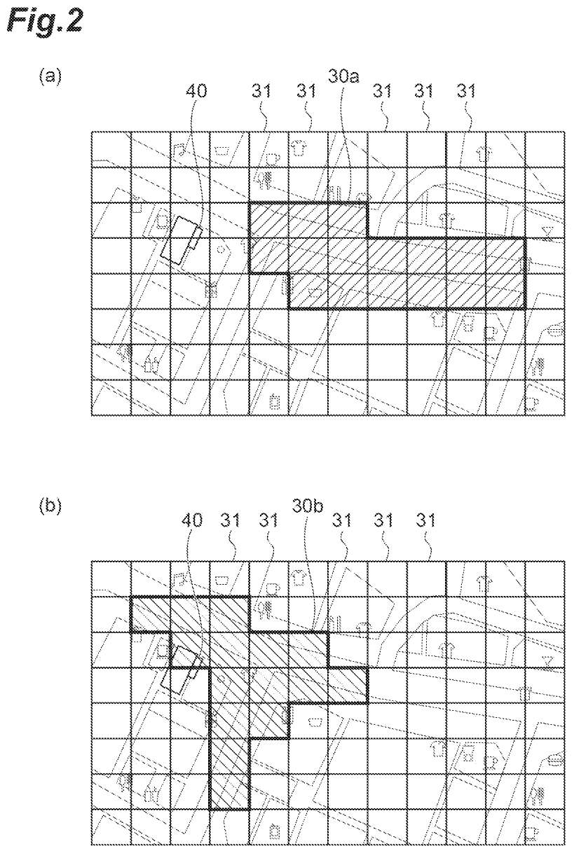

The area specified here will be described. As illustrated in FIG. 2, in the present embodiment, the specifying unit 14 specifies an area 30 (a general term for areas 30a, 30b, . . . ) configured of a plurality of mesh cells 31 as an area in which an advertisement can be recognized. The mesh cells 31 are obtained by dividing a region including the area 30, which is an estimation target, into rectangles. A size of the mesh cell 31 is set in advance and is, for example, a square having a side of 7 m. Further, the size of the mesh cell 31 may be a square having a side of 15 in or 30 in.

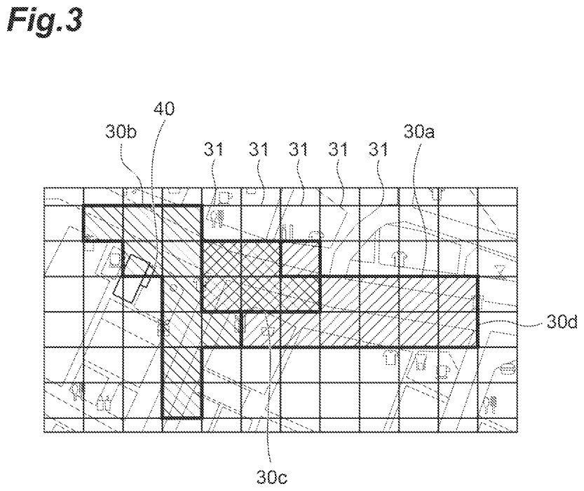

The area 30 illustrated in FIG. 2(a) is the visible area 30a in which an image displayed by the device 40, which is an infonnation medium, can be visually recognized. The area 30 illustrated in FIG. 2(b) is an acoustic arrival area 30b in which the sound output from the device 40, which is an information medium, can be audibly recognized. The specifying unit 14 may specify the respective areas 30a and 30b. Further, as illustrated in FIG. 3, the specifying unit 14 may specify a viewing area 30c including the mesh cells 31 included in both the areas 30a and 30b, or an area 30d including the mesh cells 31 included in at least one of the areas 30a and 30b. The area 30 specified by the specifying unit 14 may not be in units of the mesh cells 31 described above and may be an area having any shape and size.

Specifically, the specifying unit 14 estimates the area 30 as follows. The specifying unit 14 inputs the medium position information from the medium position information acquisition unit 11, the area specifying information from the area specifying information acquisition unit 12, and the obstacle information from the obstacle information acquisition unit 13, respectively. The specifying unit 14 estimates the area 30 based on each piece of input information.

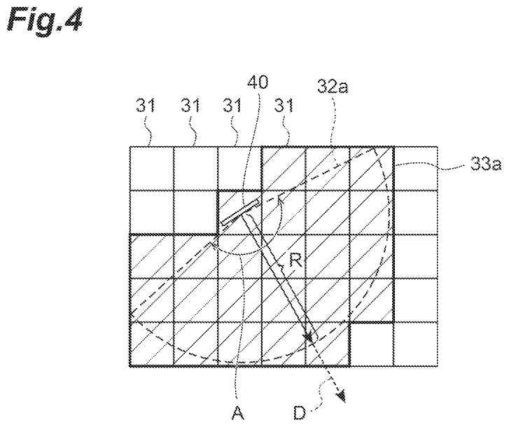

When the area 30 to be specified is the visible area 30a, the specifying unit 14 estimates the area as follows. As illustrated in FIG. 4, the specifying unit 14 sets a fan-shaped region 32a based on the input information, and sets the mesh cells 31 including the fan-shaped region 32a as a candidate area 33a that is a candidate for the visible area 30a. A position (latitude and longitude) of a central angle of the fan-shaped region 32a is a position (latitude and longitude) in which the device 40, which is an information medium, is provided, which is indicated by the medium position information. Further, a direction D of a center of the central angle of the fan-shaped region 32a (direction D in which the fan shape is directed) is a direction in which the device 40 is provided, which is indicated by the medium position information.

A radius R of the fan-shaped region 32a is a value that is set by a size and luminance of the display indicated by the area specifying information. For example, the specifying unit 14 stores an equation or a correspondence table for calculating the radius R based on the size and the luminance in advance, and calculates and sets the radius R based on the equation or the correspondence table. When the size and the luminance are higher, it is easier to recognize the advertisement and thus, the radius R is increased. Further, the radius R may be changed according to sizes of letters, characters, logos, or the like in the advertisement indicated by the area specifying information. When these sizes are larger, it is easier to recognize the advertisement and thus, the radius R is increased. For example, the following equation may be used to calculate the radius R.

R [m]=letter size [m]×250

A central angle A of the fan-shaped region 32a is a viewing angle of the display indicated by the area specifying information.

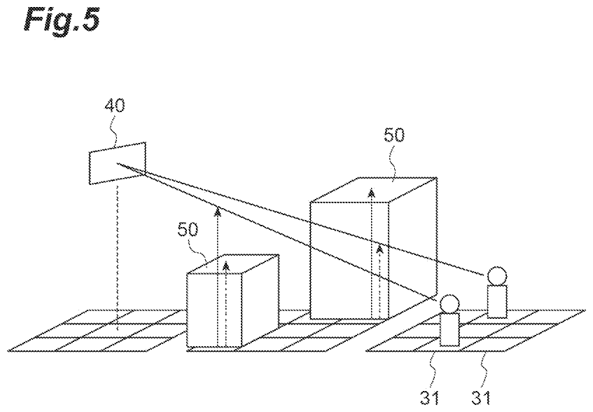

The specifying unit 14 determines whether or not a line of sight is blocked by an obstacle for each of the mesh cells 31 as the candidate area 33a. For example, the specifying unit 14 determines whether a line of sight of a person connecting a position in which the device 40 is provided, indicated by the medium position information, to a position of the person in the mesh cell 31 as illustrated in FIG. 5 is blocked by the obstacle 50 based on the obstacle information. More specifically, the position in which the device 40 is provided can be a position of a center of the display. The position of the person in the mesh cell 31 is a position of the eyes when a height of the person set in advance in a case in which the person stands at a center of the mesh cell 31 is assumed. When a place at an altitude from the ground, such as a platform of a railway station on the ground, a highway, or a building, is specified as a viewable area, the altitude of the place may be added to a height of the person and then a determination may be made as to whether the line of sight is not blocked. In this case, a determination may be made as to whether the same mesh cell is included in a viewing area for each altitude.

For example, the specifying unit 14 calculates an altitude of a line of sight in the mesh cell 31 through which the line of sight passes, compares the calculated altitude with a height of the obstacle 50 of the mesh cell 31, and determines whether the obstacle 50 is on the line of sight. When the height of the obstacle 50 is higher than an altitude of the line of sight, the specifying unit 14 determines that the line of sight is blocked by the obstacle 50, and when the height of the obstacle 50 is lower than the altitude of the line of sight, the specifying unit 14 determines that the line of sight is not blocked by the obstacle 50. The specifying unit 14 excludes the mesh cell 31 in which the line of sight is blocked by the obstacle 50 from the candidate area 33a. The specifying unit 14 specifies the mesh cell 31 not excluded from the candidate area 33a as the mesh cell 31 constituting the visible area 30a.

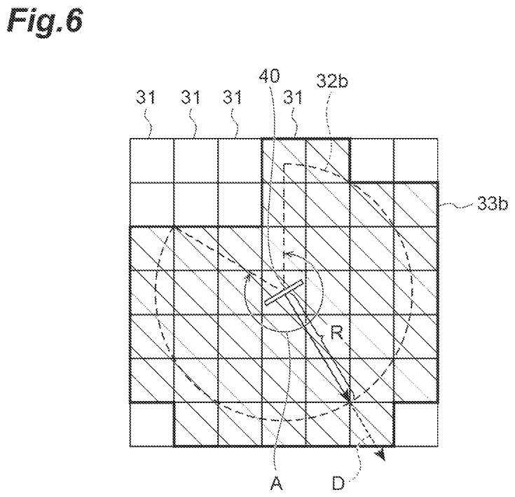

When the area 30 to be specified is the acoustic arrival area 30b, the specifying unit 14 estimates the area as follows. As illustrated in FIG. 6, the specifying unit 14 sets a fan-shaped region 32b based on the input information, and sets the mesh cell 31 including the fan-shaped region 32b as a candidate area 33b that is a candidate for the acoustic arrival area 30b. The position (latitude and longitude) of the central angle of the fan-shaped region 32b is the position (latitude and longitude) in which the device 40, which is an information medium, is provided, which is indicated by the medium position information. Further, the direction D of the center of the central angle of the fan-shaped region 32b (direction D in which the fan shape is directed) is determined based on the directionality of the sound output of the speaker indicated by the area specifying information acquisition unit 12.

The radius R of the fan-shaped region 32a is a value that is set by the volume with which a sound can be output by the speaker, which is indicated by the area specifying information. For example, the specifying unit 14 stores an equation or a correspondence table for calculating the radius R based on the volume with which a sound can be output in advance, and calculates and sets the radius R based on the equation or the correspondence table. When the volume with which a sound can be output is larger, it is easier to recognize the advertisement and thus, the radius R is increased. Further, the radius R may be changed according to the volume of the advertisement indicated by the area specifying information. When the volume of the advertisement is larger, it is easier to recognize the advertisement and thus, the radius R is increased. The central angle A of the fan-shaped region 32b is determined based on the directionality of the sound output of the speaker indicated by the area specifying infonnation.

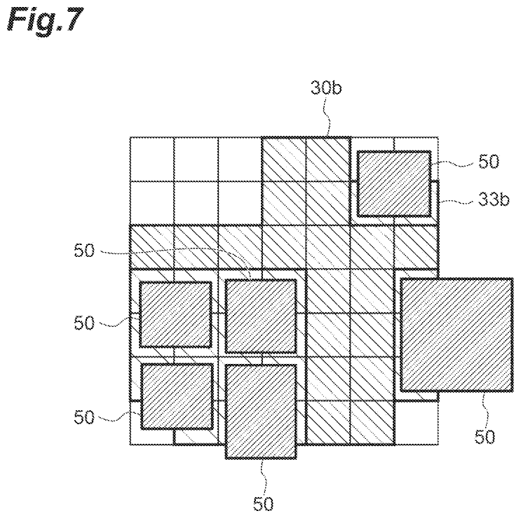

The specifying unit 14 excludes each of the mesh cells 31 as the candidate area 33b from the candidate area 33b based on the obstacle. For example, the specifying unit 14 calculates an area of the obstacle 50 in the mesh cell 31 for each of the mesh cells 31 as the candidate areas 33b as illustrated in FIG. 7. The specifying unit 14 compares an area occupied by the obstacle 50 in the mesh cell 31 with a preset threshold value, and excludes the mesh cell 31 of which the area exceeds the threshold value from the candidate area 33b. This is based on the assumption that a sound from the device 40 is blocked in the mesh cell 31 in which the obstacle 50 occupies a certain area or more. The specifying unit 14 specifies the mesh cell 31 not excluded from the candidate area 33b as the mesh cell 31 constituting the acoustic arrival area 30b.

The specifying unit 14 outputs information indicating the area 30 specified as described above to the estimation unit 15. The information indicating the area 30 is, for example, information indicating the mesh cells 31 constituting the area 30. It is not necessary for respective pieces of information used for specifying of the area 30 to be all used for specifying of the area 30, and at least one of the pieces of information may be used. Further, when the acquired information is used, the area 30 may be specified using a specific method other than the above.

The estimation unit 15 is a functional unit that estimates the number of people who can recognize the information presented by the information medium as the information based on the area 30 specified by the specifying unit 14. Specifically, the estimation unit 15 estimates (calculates) the number of people located in the area 30. The person located in the area 30 as described above can recognize the advertisement presented by the device 40. The estimation unit 15 may estimate a traffic volume of a person in a predetermined time period as the number of the person.

The estimation unit 15 inputs the information indicating the area 30 from the specifying unit 14. The estimation unit 15 receives the position information transmitted from the terminal 20 as position information indicating a position of a user who owns the terminal 20. The estimation unit 15 estimates the number of people located in the area 30 based on the input information indicating the area 30 and the received position information. The estimation of the number of people located in the area 30 based on the position information can be performed by any method, including methods of the related art.

The estimation unit 15 outputs information indicating the estimated number of people located in the area 30. The output of the information may be performed on, for example, a display device included in the estimation unit 15, or may be performed on another device, a module, or the like. Using the number of people estimated by the estimation unit 15, it is possible to evaluate the advertisement or the advertising space. The above is a function of the area specifying system 10 according to the present embodiment.

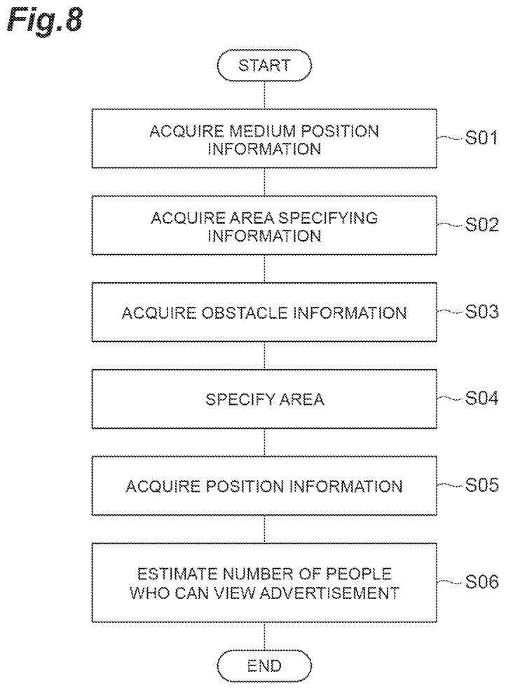

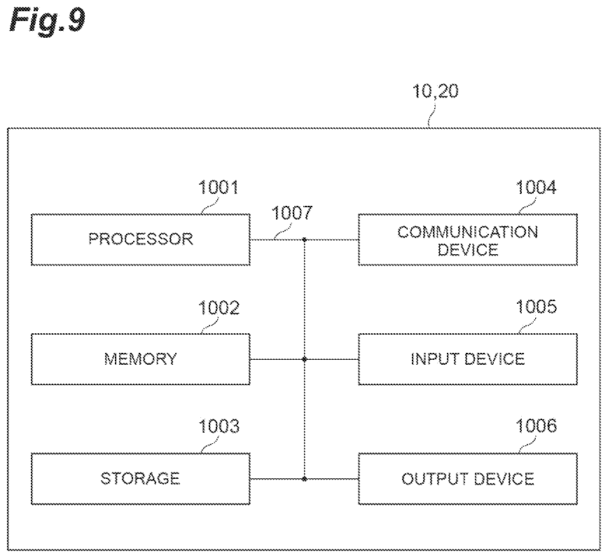

Subsequently, a process executed by the area specifying system 10 according to the embodiment (an operation method performed by the area specifying system 10) will be described using the flowchart of FIG. 8. In the present process, the medium position information acquisition unit 11 acquires the medium position information indicating a position in which the device 40 that presents an advertisement, which is an information medium, is provided (S01). Further, the area specifying information acquisition unit 12 acquires area specifying information related to at least one of the attributes of the device 40 and the content of the information presented by the device 40 (S02). Further, the obstacle information acquisition unit 13 acquires obstacle information indicating obstacles around the position in which the device 40 is provided (S03). The process of acquiring the information in SO1 to S03 does not necessarily have to be performed in the above order, and may be performed in any order as long as the process is performed up to the following specifying of the area 30.

Subsequently, the specifying unit 14 specifies the area 30 in which the advertisement presented by the device 40 can be recognized as the advertisement based on the medium position information, the area specifying information, and the obstacle information (S04). Subsequently, the estimation unit 15 receives and acquires the position information from the terminal 20 (S05). Subsequently, the estimation unit 15 estimates and outputs the number of people located in the area 30, that is, the number of people who can view the advertisement presented by the device 40 (S06). The above is a process that is executed by the area specifying system 10 according to the present embodiment.

In the present embodiment, the area 30 is specified based on the area specifying information. Therefore, it is possible to specify the area 30 in which the advertisement can be appropriately recognized, based on at least one of the attributes of the device 40 that presents the advertisement and the content of the advertisement, rather than simply seeing or hearing the advertisement.

Further, when the device 40 that presents an advertisement includes a display or a speaker, the area specifying information can be one described above. According to this configuration, the area 30 can be appropriately and reliably specified according to the capacity of the device 40 or the content of the advertisement. However, the area specifying information is not limited to the specific example of the embodiment, and may be any information based on at least one of the attributes of the device 40 that presents the advertisement and the content of the advertisement.

Further, the area 30 may be specified based on the obstacle information as in the present embodiment. According to this configuration, it is possible to appropriately specify the area 30 even when a structure such as a building is around the device 40. However, the area 30 may be specified without using the obstacle information.

Further, the number of people who can recognize the advertisement presented by the device 40 as the advertisement may be estimated based on the area 30 specified as in the present embodiment. According to this configuration, it is possible to also evaluate an advertisement or an advertising space based on the specified area 30. However, the area specifying system 10 does not need to estimate the number of people as described above, and the number of people may be estimated by another device or the like. In this case, the area specifying system 10 outputs information indicating the specified area 30 to the other device or the like. Further, the area 30 specified by the area specifying system 10 may be used for purposes other than the estimation of the number of people.

In the above-described embodiment, the area specified by the area specifying system 10 is an area related to advertisement. However, the area specified by the area specifying system 10 does not have to be related to the advertisement, and may be related to any information presented by any information medium.

Further, in the present embodiment, the information medium is the device 40 including a display, a speaker, and the like, but the information medium is not limited to such a device 40 and any device that presents information can be used.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but the present disclosure is not limited thereto. For example, a functional block (a component) that functions for transmission is referred to as a transmitting unit or a transmitter. In any case, a realizing method is not particularly limited, as described above.

For example, the area specifying system 10 in an embodiment of the present disclosure may function as a computer that performs processes of the method of the present disclosure. FIG. 9 is a diagram illustrating an example of a hardware configuration of the area specifying system 10 according to an embodiment of the present disclosure. The area specifying system 10 described above may be physically configured as a computer device including a processor 1001, a memory 1002, a storage 1003, a communication device 1004, an input device 1005, an output device 1006, a bus 1007, and the like. Further, the terminal 20 according to the embodiment may also have the same hardware configuration as in the present description.

In the following description, the term “device” can be read as a circuit, a device, a unit, or the like. The hardware configuration of area specifying system 10 may be configured to include one or a plurality of illustrated devices or may be configured without including some of the devices.

Each function in the area specifying system 10 is realized by loading predetermined software (a program) into hardware such as the processor 1001 or the memory 1002 so that the processor 1001 performs calculation to control communication that is performed by the communication device 1004 or reading and/or writing of data in the memory 1002 and the storage 1003.

The processor 1001, for example, operates an operating system to control the entire computer. The processor 1001 may be configured as a central processing unit (CPU) including an interface with a peripheral device, a control device, a calculation device, a register, and the like. For example, each function in the area specifying system 10 may be realized by the processor 1001.

Further, the processor 1001 loads a program (program code), a software module, or data from at least one of the storage 1003 and the communication device 1004 into the memory 1002 and executes various processes according to the program, the software module, or the data. As the program, a program for causing the computer to execute at least some of the operations described in the above embodiment may be used. For example, each function in the area specifying system 10 may be realized by a control program stored in the memory 1002 and operating on the processor 1001. Although the case in which the various processes described above are executed by one processor 1001 has been described, the processes may be executed simultaneously or sequentially by two or more processors 1001. The processor 1001 may be implemented by one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RANI). The memory 1002 may be referred to as a register, a cache, a main memory (a main storage device), or the like. The memory 1002 can store an executable program (program code), software modules, and the like in order to implement a method according to the embodiment of the present disclosure.

The storage 1003 is a computer-readable recording medium and may be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via a wired network and a wireless network and is also referred to as a network device, a network controller, a network card, or a communication module, for example. For example, each function in the area specifying system 10 described above may be realized by the communication device 1004.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, each device such as the processor 1001 and the memory 1002 is connected by the bus 1007 for communicating information. The bus 1007 may be configured by using a single bus, or may be configured by using a different bus for each device.

Further, the area specifying system 10 may include hardware such as a microprocessor, a digital signal processor (DSP), an application specific integrated circuit (ASIC), a programmable logic device (PLD), and a field programmable gate array (FPGA), and some or all of respective functional blocks may be realized by the hardware. For example, processor 1001 may be implemented using at least one of these pieces of hardware.

A process procedure, a sequence, a flowchart, and the like in each aspect/embodiment described in the present disclosure may be in a different order unless inconsistency arises. For example, for the method described in the present disclosure, elements of various steps are presented in an exemplary order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to being made explicitly, and may be made implicitly (for example, a notification of the predetermined information is not made).

Although the present disclosure has been described above in detail, it is obvious to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for exemplification, and does not have any restrictive meaning with respect to the present disclosure.

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless of whether the software may be called software, firmware, middleware, microcode, or hardware description language or called another name.

Further, software, instructions, information, and the like may be transmitted and received via a transmission medium. For example, when software is transmitted from a website, a server, or another remote source using at least one of a wired technology (a coaxial cable, an optical fiber cable, a twisted pair, a digital subscriber line (DSL), and the like) and a wireless technology (infrared rays, microwaves, and the like), the at least one of the wired technology and a wireless technology is included in the definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or any combination of these.

The terms described in the present disclosure and/or terms necessary for understanding of the present disclosure may be replaced by terms having the same or similar meanings. For example, at least one of a channel and a symbol may be a signal (signaling). Further, the signal may be a message.

Further, information, parameters, and the like described in the present disclosure may be represented by an absolute value, may be represented by a relative value from a predetermined value, or may be represented by corresponding different information.

Names used for the above-described parameters are not limiting names in any way. Further, equations or the like using these parameters may be different from those explicitly disclosed in the present disclosure.

The term “determining” used in the present disclosure may include a variety of operations. The “determining” can include, for example, regarding judging, calculating, computing, processing, deriving, investigating, searching (looking up or inquiry) (for example, looking up in a table, a database or another data structure), or ascertaining as “determining”. Further, “determining” can include, for example, regarding receiving (for example, receiving information), transmitting (for example, transmitting information), inputting, outputting, or accessing (for example, accessing data in a memory) as “determining”. Further, “determining” can include regarding resolving, selecting, choosing, establishing, comparing or the like as “determining”. That is, “determining” can include regarding a certain operation as “determining”. Further, “determining” may be read as “assuming”, “expecting”, “considering”, or the like.

The terms “connected”, “coupled”, or any modification thereof means any direct or indirect connection or coupling between two or more elements, and can include the presence of one or more intermediate elements between two elements “connected” or “coupled” to each other. The coupling or connection between elements may be physical, may be logical, or may be a combination thereof. For example, “connection” may be read as “access.” When used in the present disclosure, two elements can be considered to be “connected” or “coupled” to each other by using at least one of one or more wires, cables, and printed electrical connections, and by using electromagnetic energy having wavelengths in a radio frequency region, a microwave region, and a light (both visible and invisible) region as some non-limiting and non-comprehensive examples.

The description “based on” used in the present disclosure does not mean “based only on” unless otherwise noted. In other words, the description “based on” means both of “based only on” and “at least based on”.

Any reference to elements using designations such as “first” and “second” as used in this disclosure does not generally limit an amount or order of those elements. These designations can be used in the present disclosure as a convenient way to distinguish between two or more elements. Thus, the reference to the first and second elements does not mean that only two elements can be adopted or that the first element has to precede the second element in some way.

As long as “include”, “including” and variations thereof are used in the present disclosure, those terms are intended to be comprehensive like the term “comprising”. Further, the term “or” used in the present disclosure is intended not to be an exclusive OR.

In the present disclosure, for example, when articles such as a, an, and the in English are added by translation, the present disclosure may include that nouns following these articles are plural.

In the present disclosure, a sentence “A and B differ” may mean that “A and B are different from each other.” The sentence may mean that “each of A and B is different from C.” Terms such as “separate”, “coupled”, and the like may also be interpreted, similar to “different.”

### REFERENCE SIGNS LIST

10: Area specifying system

11: Medium position information acquisition unit

12: Area specifying information acquisition unit

13: Obstacle information acquisition unit

14: Specifying unit

15: Estimation unit

20: Terminal

1001: Processor

1002: Memory

1003: Storage

1004: Communication device

1005: Input device

1006: Output device

1007: Bus

1. An area specifying system for specifying an area in which information presented by an information medium is recognizable as the information, the area specifying system comprising circuitry configured to:
acquire medium position information indicating a position in which the information medium is provided;
acquire area specifying information related to at least one of attributes of the information medium and content of the information presented by the information medium; and
specify the area based on the medium position information and the area specifying information.

2. The area specifying system according to claim 1, wherein the circuitry acquires information indicating capability of the information medium as the area specifying information.

3. The area specifying system according to claim 2,
wherein the information medium includes a display, and
the circuitry acquires information indicating at least one of a viewing angle and luminance of the display as the information indicating the capability of the information medium.

4. The area specifying system according to claim 2,
wherein the information medium includes a speaker, and
the circuitry acquires information indicating at least one of directionality of a sound output of a speaker and a volume with which a sound is able to be output as information indicating the capability of the information medium.

5. The area specifying system according to claim 1,
wherein the information medium includes a display, and
the circuitry acquires information indicating a size of an object displayed by the display as the area specifying information.

6. The area specifying system according to claim 1,
wherein the information medium includes a speaker, and
the circuitry acquires information related to a sound output from the speaker as the area specifying information.

7. The area specifying system according to claim 1,
wherein the circuitry acquires obstacle information indicating obstacles around the position in which the information medium is provided, and
specifies the area also based on obstacle information.

8. The area specifying system according to claim 1, wherein the information presented by the information medium is an advertisement.

9. The area specifying system according to claim 1, wherein the circuitry estimates the number of people capable of recognizing the information presented by the information medium as the information based on the area.

10. The area specifying system according to claim 3,
wherein the information medium includes a speaker, and
the circuitry acquires information indicating at least one of directionality of a sound output of a speaker and a volume with which a sound is able to be output as information indicating the capability of the information medium.
